(19) United States
(12) Patent Application Publication
(10) Pub. No.: US 2026/0015985 A1
(43) Pub. Date: Jan. 15, 2026

(54) FUEL CIRCUIT FOR AN APPARATUS, ASSOCIATED APPARATUS AND METHOD

(71) Applicant: VOLVO TRUCK CORPORATION, Göteborg (SE)

(72) Inventors: François GIROUD, Lyon (FR); Yann Ardouin, Genas (FR); Mickael Jondeau, Villeurbanne (FR); Hellal Benzaoui, Pierre Benite (FR)

(73) Assignee: VOLVO TRUCK CORPORATION, Göteborg (SE)

(21) Appl. No.: 19/266,298

(22) Filed: Jul. 11, 2025

(30) Foreign Application Priority Data
Jul. 15, 2024 (EP) 24188601.9

(51) Int. Cl. F02D 41/22; F02M 37/40

(52) U.S. Cl. CPC F02D 41/22; F02M 37/40; F02D 2041/224; F02D 2200/0602

(57) ABSTRACT

This fuel circuit has a pumping device with a low-pressure stage and a high-pressure stage. The fuel circuit is configured to supply, at high-pressure, fuel collected from a fuel tank to injectors of an engine. A low-pressure circuit and a high-pressure circuit are included. A fuel filter, is arranged between an outlet of the low-pressure stage and an intake of the high-pressure stage. V fist pressure sensor is arranged upstream from the fuel filter, and a second pressure sensor is arranged between the fuel filter and the intake of the high-pressure stage.

### TECHNICAL FIELD

The invention relates generally a fuel circuit for an apparatus, for example for a vehicle, and to an apparatus comprising such a fuel circuit. The invention also relates to a method for evaluating fuel filter clogging in fuel circuit for an internal combustion engine, for example for a vehicle with an internal combustion engine, and to a vehicle comprising such a fuel circuit. The invention can be applied to vehicles, for example heavy-duty vehicles, such as trucks, buses, and construction equipment, among other vehicle types. Although the disclosure may be described with respect to a particular vehicle, the disclosure is not restricted to any particular vehicle. The disclosure can also be applied to stationary applications, such as generating sets—also called “gensets”—.

### BACKGROUND

Modern internal combustion engine are equipped with a fuel circuit comprising a pumping device, which is configured to pump fuel from a fuel tank to injectors of the engine. In the scope of the present invention, the pumping device comprises two-stages, with a low-pressure stage and a high-pressure stage. The pumping device is preferably a two-stage pump, which integrates the low-pressure stage and the high-pressure stage into one unit.

The fuel circuit comprises a low-pressure circuit, which connects the fuel tank to the low-pressure stage and which feeds fuel into an intake of the high-pressure stage, and a high-pressure circuit, which connects an output of the high-pressure stage to the injectors. The high-pressure circuit usually comprises a distribution device called common rail, on which the injectors are mounted. The high-pressure circuit also comprises a pressure relief valve, or PRV in short, which is configured to allow fuel from the high-pressure circuit to return to the fuel tank when fuel pressure in the high-pressure circuit is too high, or when the vehicle is powered off.

The fuel circuit also comprises a filter, which is arranged on the low-pressure circuit between the low-pressure stage and the intake of the high-pressure stage, in order to prevent impurities to enter the high-pressure stage and, further, into the injectors. As time passes, the amount of impurities captured by the filter increases, which might lead to decrease of the filter efficiency and/or increased wear of the pumping device.

There is, however, a need for an improved fuel circuit, allowing for better evaluation of filter state of health.

### SUMMARY

According to a first aspect of the disclosure, the invention concerns a fuel circuit, which comprises:
a pumping device comprising a low-pressure stage and a high-pressure stage, the fuel circuit being configured to supply, at high-pressure, fuel collected from a fuel tank to injectors of an engine,
a low-pressure circuit and a high-pressure circuit,
a fuel filter, which is arranged between an outlet of the low-pressure stage and an intake of the high-pressure stage,
a fist pressure sensor arranged upstream from the fuel filter, and
a second pressure sensor arranged between the fuel filter and the intake of the high-pressure stage.

The first aspect of the disclosure may seek to allow measurement of fuel pressure downstream from the filter, with a pressure sensor that is always available. A technical benefit may include allowing continuous monitoring of fuel pressure, which is linked to filter state of health, thus allowing fault detection of the fuel circuit and maintenance planning of the filter.

Optionally in some examples, including in at least one preferred example:

The fuel circuit further comprises:
a pressure relief valve, which is arranged on the high-pressure circuit, and
a control unit, which is configured to control the pumping device and the pressure relief valve, and to evaluate a differential pressure of the filter when fuel flows through the filter.

A technical benefit may include increasing flow through the filter above a level that is usually met under normal operating conditions, thus allowing more precise measurement of differential pressure as fuel flows through the filter, thus leading to a more precise diagnostic of filter clogging.

Optionally in some examples, including in at least one preferred example, the invention also concerns an apparatus, comprising:
an engine with injectors, which are configured to inject fuel at high-pressure into cylinders of the engine,
the fuel tank, and
the fuel circuit according as previously defined.

Optionally in some examples, including in at least one preferred example, the apparatus is a vehicle or a power generator.

According to a second aspect of the disclosure, the invention concerns a method to evaluate clogging of a fuel filter of a fuel circuit for an apparatus, the method comprising:
pumping fuel, with a pumping device of the fuel circuit, the pumping device comprising a low-pressure stage and a high-pressure stage, the fuel circuit comprising a low-pressure circuit with the fuel filter and a high-pressure circuit, the fuel filter being arranged between an outlet of the low-pressure stage and an intake of the high-pressure stage,
while pumping fuel, measuring a fuel pressure downstream of the fuel filter, with a pressure sensor arranged between the fuel filter and the intake of the high-pressure stage,
with a control unit, comparing the measured fuel pressure with expected values of the fuel pressure, the expected values being preferably stored in a memory of the control unit.

A technical benefit may include assessing filter state of health and/or fuel circuit functioning. The presence of a pressure sensor downstream of the filter enables several strategies for continuous monitoring and/or more precise clogging evaluation.

Optionally in some examples, including in at least one preferred example:
measuring fuel pressure downstream of the fuel filter occurs during a startup period of the apparatus, the measured fuel pressure being initially zero,
when comparing the measured fuel pressure with expected values of the fuel pressure, the control unit is configured to report a fault if the measured fuel pressure does not reach a predetermined threshold before a predetermined time, the predetermined threshold and the predetermined time being preferably stored in a memory of the control unit.

A technical benefit may include giving an early alert, at startup, before the engine runs at higher load.

Optionally in some examples, including in at least one preferred example:
measuring fuel pressure downstream of the fuel filter occurs after a startup period of the apparatus, the fuel pressure varying according to operating conditions of the apparatus,
when comparing the measured fuel pressure with expected values of the fuel pressure, for any possible operating condition of the apparatus, a fault is reported if the measured fuel pressure does not stay within a range of expected values, the range of expected value being delimited, between a minimal value and a maximal value, the minimal value and the maximal value being each function of the operating conditions.

A technical benefit may include monitoring the apparatus during its whole operating cycle, thus leading to a diagnostic under various operating conditions.

Optionally in some examples, including in at least one preferred example:
while pumping fuel, opening a pressure relief valve of the high-pressure circuit, in order to increase fuel flow through the fuel filter above a pre-determined threshold,
while pumping fuel and while the pressure relief valve is open, measuring a differential pressure of the fuel filter, with the first pressure sensor and the second pressure sensor.

A technical benefit may include increasing flow through the filter, independently of actual fuel consumption, in order to magnify pressure loss and thus giving a more precise evaluation of filter clogging.

Optionally in some examples, including in at least one preferred example:
While measuring differential pressure of the filter, at least 50% of the fuel pumped in the high-pressure circuit flows through the pressure relief valve.
While measuring differential pressure of the filter, 100% of the fuel pumped by the pumping device flows back to the fuel tank.
While measuring differential pressure of the filter, the engine runs at a constant speed.
The apparatus being a vehicle, while measuring differential pressure of the filter, the vehicle is using engine brake and/or electromagnetic brake.
While measuring differential pressure of the filter, the fuel flow through the filter is higher than ten times a fuel consumption of the engine when the engine is idling, preferably higher than twenty times, preferably higher than thirty times, preferably higher than forty times.
While measuring differential pressure of the filter, the fuel flow through the filter is at least four time higher than an average consumption of the engine, preferably five times higher, preferably eight times higher, preferably ten times higher, preferably twenty times higher.
Differential pressure of the filter is measured several times during an operating cycle of the apparatus, whereas each measured value is divided by an end of life value of the differential pressure, then averaged, in order to calculate a ratio representative of remaining lifetime of the filter.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

FIG. 1 is an exemplary apparatus according to an exemplary embodiment of the invention.

FIG. 2 represents, on two inserts a) and b), graphs illustrating embodiments of the inventions;

FIG. 3 is a diagram illustrating an exemplary method according to the invention.

FIG. 4 is a graph illustrating results of the method according to the invention.

### DETAILED DESCRIPTION

The detailed description set forth below provides information and examples of the disclosed technology with sufficient detail to enable those skilled in the art to practice the disclosure.

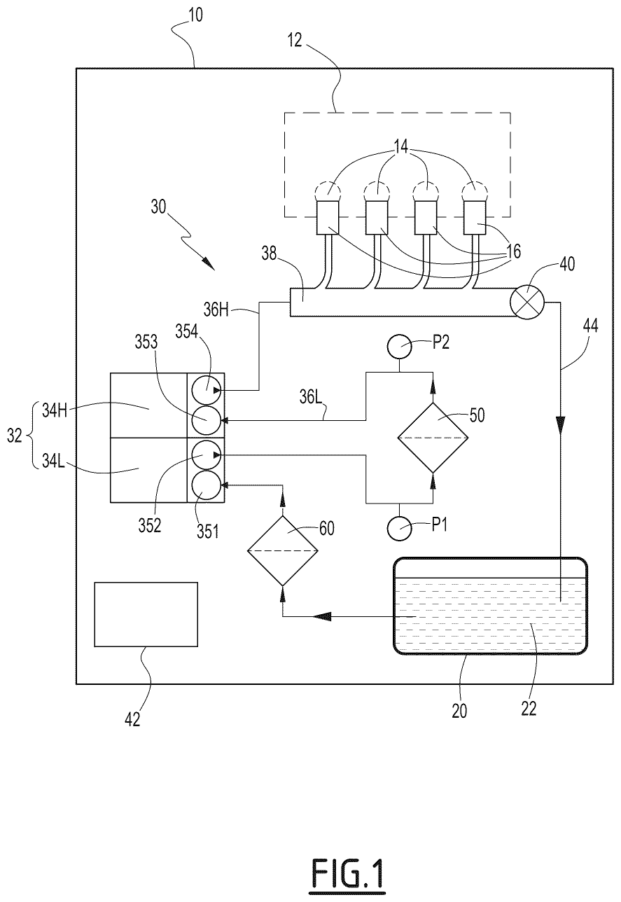

FIG. 1 is an exemplary apparatus 10, according to an exemplary embodiment of the invention. The apparatus 10, which is here schematically represented by a rectangle, comprises an engine 12. The engine 12 is schematically represented by a box in dashed line. The engine 12 is an internal combustion engine, also designated by the acronym ICE. In the illustrated example, the apparatus 10 is a vehicle, in particular a road vehicle, such as a truck, or a bus. In other words, the apparatus 10 is mobile. Alternatively, the apparatus 10 is stationary, for example, the apparatus is a generator set, which produces electricity.

The engine 12 comprises several cylinders 14, here represented in dotted line, and several injectors 16. In the illustrated example, each cylinder 14 is associated with one respective injector 16. The number of cylinders 14 or injectors 16 is not limited to the illustrated embodiment. The apparatus 10 also comprises a tank 20 configured to contain fuel 22 in liquid form at ambient temperature. In other words, the tank 20 is a fuel tank. In the illustrated example, the tank 20 is represented inside the apparatus 10. In other words, the tank 20 is embarked in the apparatus 10. In a not-shown alternative, the tank 20 is located outside the apparatus 10. When the apparatus 10 is functioning properly, the tank 20 contains fuel 22. In the present example, the fuel tank 20 contains diesel fuel. However, the invention is not limited to any particular type of fuel. Alternatively, the fuel is gasoline, avgas, etc.

The apparatus 10 also comprises a fuel circuit 30. The fuel circuit 30 comprises a pumping device 32. The pumping device 32 is configured to pump fuel 22 from the tank 20 to the injectors 16, in order to inject the pumped fuel into the cylinders 14. Within the tank 20, fuel 22 is usually at a pressure close to atmospheric pressure, that is to say sensibly 1 bar. In order to inject fuel into the cylinders, the pumping device 32 raises the pressure to a high level, typically from 300 to 2000 bars.

To this end, the pumping device 32 comprises a low-pressure stage 34L and a high-pressure stage 34H. The low-pressure stage 34L is configured to collect fuel 22 from the tank 20 and to supply the high-pressure stage 34H with the fuel collected from the tank 20, while the high-pressure stage 34H feed the injectors 16 with fuel at high-pressure. As in the illustrated example of FIG. 1, the pumping device 32 is preferably a two-stage pump, which includes the low-pressure stage 34L and the high-pressure stage 34H within a single device. In a not-shown alternative, the low-pressure stage 34L and the high-pressure stage 34H are separated from each other.

The low-pressure stage 34L comprises a first intake 351 and a first outlet 352. The high-pressure stage 34H comprises a second intake 353 and a second outlet 354. The first intake 351 is fluidically connected to the tank 20. The first outlet 352 of the low-pressure stage 34L is connected to the second intake 353 of the high-pressure stage 34H by a low-pressure circuit 36L. The second outlet 354 of the high-pressure stage 34H is connected to the injectors 16 by a high-pressure circuit 36H. The low-pressure circuit 36L and the high-pressure circuit 36H belong to the fuel circuit 30. In modern engines, the injectors 16 are usually connected to a common fuel distribution manifold called “common rail” 38. The common rail 38 is part of the high-pressure circuit 36H.

Preferably, the fuel circuit 30 also comprises a relief valve 40, which is arranged on the high-pressure circuit 36H. Preferably, the relief valve 40 is arranged on the common rail 38. The relief valve 40 is configured to be controlled by a control unit 42 of the apparatus 10, so that fuel contained within the high-pressure circuit 36H may flow back to the tank 20 through a relief duct 44. The relief valve 40 is preferably a solenoid valve. As an illustration, when the engine 12 is running, fuel pressure within the common rail 38 may reach pressure as high as 2000 bar. When the engine is turned off, the relief valve 40 is opened to decrease pressure within the high-pressure circuit 36H and avoid fuel leaks. In the illustrated example, the control unit 42 is an electronic control unit, or ECU. More generally, the control unit 42 is configured to control the pumping device 32 and the pressure relief valve 40.

The fuel circuit 30 also comprises a filter 50. The filter 50 is a fuel filter, which is arranged between the first outlet 352 of the low-pressure stage 34L and the second intake 353 of the high-pressure stage 34H. In other words, the filter 50 is arranged on the low-pressure circuit 36L. The filter 50 is configured to capture impurities present in the fuel 22 circulating within the low-pressure circuit 36L, so as to prevent impurities to penetrate within the high-pressure stage 34H and the high-pressure circuit 36H and, ultimately, within the injectors 16, risking damaging the injectors 16.

Usually, the fuel circuit 30 also comprises another filter, called primary filter 60, whereas the filter 50 is also called “main filter”. The primary filter 60 is arranged between the tank 20 and the first intake 351 of the low-pressure stage 34L.

The fuel circuit 30 also comprises a first pressure sensor P1. In the illustrated example, the first pressure sensor P1 is arranged on the low-pressure circuit 36L between the first outlet 352 of and the filter 50. In other words, the first pressure sensor P1 is arranged upstream from the filter 50. The second pressure sensor P1 is configured to measure an upstream fuel pressure, that is to say a fuel pressure within the low-pressure circuit 36L upstream from the filter 50.

The fuel circuit 30 also comprises a second pressure sensor P2, which is arranged on the low-pressure circuit 36L between the filter 50 and the second intake 353 of the high-pressure stage 34H. In other words, the second pressure sensor P2 is arranged downstream from the filter 50. The second pressure sensor P2 is configured to measure a downstream fuel pressure, that is to say a fuel pressure within the low-pressure circuit 36L downstream from the filter 50.

The control unit 42 is configured to receive data from the second pressure sensor P2, in order to evaluate a charge loss when fuel flows through the filter 50 and, ultimately, evaluate a clogging state of the filter 50, that is to say a state of health of the filter 50. When fuel flows through the filter 50, charge loss is related to differential pressure ΔP upstream and downstream of the filter 50, and to the amount of fuel flowing through the filter.

The control unit 42 is configured to receive data from the first pressure sensor P1, the differential pressure ΔP being equal to the difference between the measurements of the second pressure sensor P2 and the first pressure sensor P1. In a not shown alternative, pressure upstream from the filter 50 is given by the low-pressure stage 34L of the pumping device 32.

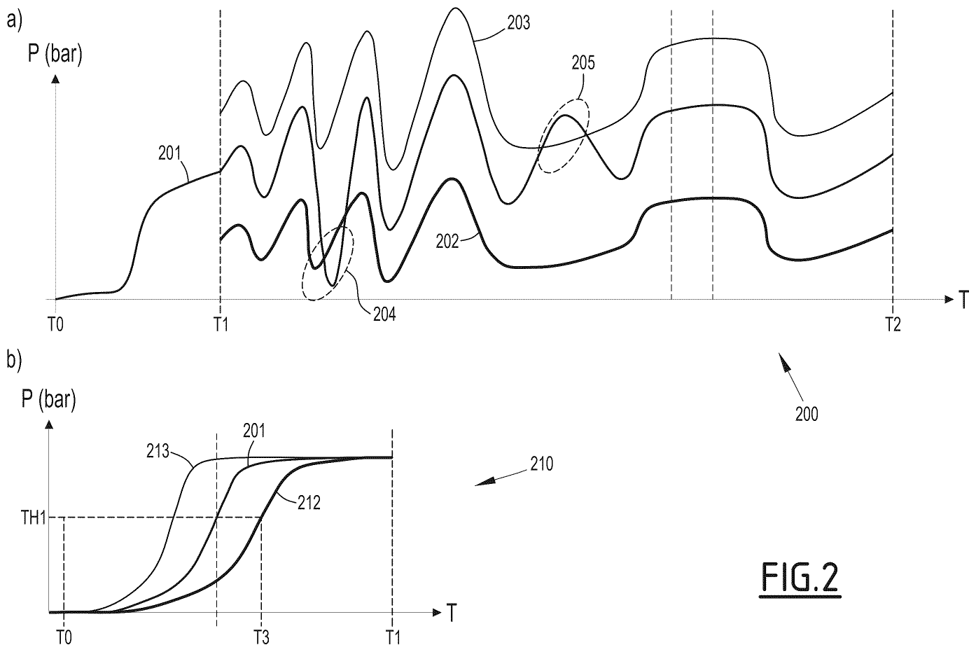

An aspect of the invention concerns monitoring measured fuel pressure downstream of the fuel filter 50, during various functioning phases of the apparatus 10, in particular measuring downstream fuel pressure, which is here measured with the second pressure sensor P2. Insert a) of FIG. 2 is a graph 200 comprising a first curve 201 showing the evolution of downstream fuel pressure as a function time. At an initial time T0, the apparatus 10 and the engine 12 are stopped, and fuel pressure within the fuel circuit 30 is zero. From the initial time T0 until a first time T1, the engine 12 is started, and fuel pressure—in particular downstream fuel pressure—increases until reaching a sensibly stable value. After the first time T1, and until a second time T2, the apparatus 10 is operated under variable conditions. For example, when the apparatus 10 is a vehicle, these various conditions may include moving back and forth at low speed on in a parking, running on open road, uphill or downhill, on a highway, etc. In other words, after the startup period, the fuel pressure varies, depending on operating conditions of the engine 12.

For any given running conditions of the engine 12 between the first time T1 and second time T2, fuel pressure in any point of the fuel circuit 30 must fall between two minimum and maximum values that represent the range of normal operating values. On insert a) of FIG. 2, the graph 200 comprises a minimal curve 202, which illustrates, for any instant between the first time T1 and the second time T2, the minimum acceptable value of fuel pressure according to normal operating conditions of the apparatus 10. In an analog manner, the graph 200 comprises a maximal curve 203, which illustrates, for any instant between the first time T1 and the second time T2, the maximum acceptable value of fuel pressure according to normal operating conditions of the apparatus 10. For example, the minimal curve 202 and the maximal values 203 are set according to a calibrated value for the engine 12. Alternatively, the minimal curve 202 and the maximal values 203 are set according to a model of the fuel circuit 30.

At any given time, the minimal curve 202 is inferior to the maximal curve 203. The minimal curve 202 and the maximal curve 203 delimit together a range of expected values of the fuel pressure. If the measured pressure value goes outside of the acceptable value range, for example as illustrated within ellipsis 204 and 205 on graph 200, then a fault is reported to help fault tracing.

Insert b) of FIG. 2 is a graph 210 showing, at higher scale, the startup period from T0 to T1. Dysfunction of the system may be detected in case fuel pressure doesn't reach a given value within a given time. In the example of FIG. 2 b), if the downstream fuel pressure, illustrated by the first curve 201, does not reach a first threshold TH1 before a third time T3, then a fault is reported. Such a fault may be the sign that the filter 50 is clogged, or that the pumping device 32 does not work properly, etc.

Alternatively, the range of acceptable values, minimal or maximal, that may be reached by the measured fuel pressure during the startup period, may be shown by two curves 212 and 213 that delimit, for any five time during the startup period, the acceptable range of measured pressure value.

According to another aspect of the invention, the control unit 42 is also configured to receive data, from the pumping device 32, regarding the quantity of fuel flowing through the filter 50, in other words the throughput of the low-pressure stage 34L. The control unit 42 also comprises a clogging model of the filter 50, which links the differential pressure ΔP of the filter 50, the quantity of fuel flowing through the filter 50 and an indicator related to clogging, i.e. state of health, of the filter 50. Preferably, the clogging model is registered in advance in a memory of the control unit 42.

Schematically, charge loss is linked to the loss of kinetic energy of the fuel flowing through the filter, which is linked to a state of health of the filter 50. As a schematic rule, for a filter with a given clogging state, charge loss is proportional to the square of the speed through this filter. In other words, the differential pressure ΔP is proportional to the share of the flow through the filter 50, the fuel being considered as an incompressible fluid.

As a result, for a given filter 50 with a given state of health, the higher the speed through the filter, the higher the charge loss. An ingenious principle behind the invention is to use the open the relief valve 40 in order to increase fuel flow through the filter 50, thus evaluating clogging and state of health of the filter 50 with a higher accuracy.

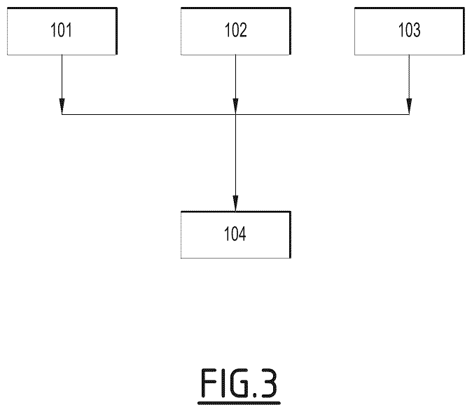

Accordingly, the invention concerns a method to evaluate fuel filter 50 clogging. The main steps of the method are illustrated on FIG. 3. The method comprises a first step 101, which includes pumping fuel, with the pumping device 32 comprising the low-pressure stage 34L and the high-pressure stage 34H, in the fuel circuit 30. The fuel circuit 30 comprises the low-pressure circuit 36L with the filter 50 and the high-pressure circuit 36H. The filter 50 is arranged between the outlet 352 of the low-pressure stage 34L and the intake 353 of the high-pressure stage 34H. In the preferred illustrated example, the pumping device 32 is controlled by the control unit 42.

The method comprises a second step 102, which occurs simultaneously with the first step 101. While pumping fuel, the relief valve 40 is opened, in order to increase fuel flow through the fuel circuit 30 above a pre-determined threshold. In the preferred illustrated example, the relief valve 40 is controlled by the control unit 42.

The method comprises a third step 103, which includes in measuring differential pressure ΔP of the filter 50. Differential pressure ΔP is measured with the second pressure sensor P2 arranged between the fuel filter 50 and the intake 353 of the high-pressure stage 34H of the pumping device 32. The third step occurs simultaneously with the first step 101 and the second step 102. In other words, pressure downstream of the filter 50 is measured while pumping fuel and while the relief valve 40 is open. In the preferred illustrated example, measurement values of the pressure are received and registered by the control unit 42.

The method comprises a fourth step 104, which includes evaluating a state of health of the filter 50 by comparing measured values of the differential pressure ΔP, evaluated during the third step 103, with a clogging model of the filter 50. In the preferred illustrated example, the clogging model of the filter 50 is registered in advance in the control unit 42, and the evaluation of the state of health of the filter is also performed by the control unit 42. According to examples, the method strategy relies on measuring differential pressure ΔP in the fuel circuit 30, the measure value being subsequently divided by an end of life value of the differential pressure, in order to calculate a ratio representative of remaining lifetime of the filter. For example, the end of life value represents, for a given flow through the filter, the differential pressure measured when the fuel filter is clogged at a maximal acceptable level. Preferably, this ratio is calculated several times during an operating cycle of the apparatus 10 and then averaged before sending feedback to the user.

In the illustrated example, the fourth step 104 occurs after the first step 101, the second step 102 and the third step 103 are over. Alternatively, the third step 103 is repeated several times, in other words differential pressure ΔP is measures several times while the first step 101 and the second step 102 are still ongoing. Accordingly, the fourth step 104 of state of health evaluation is also repeated several times.

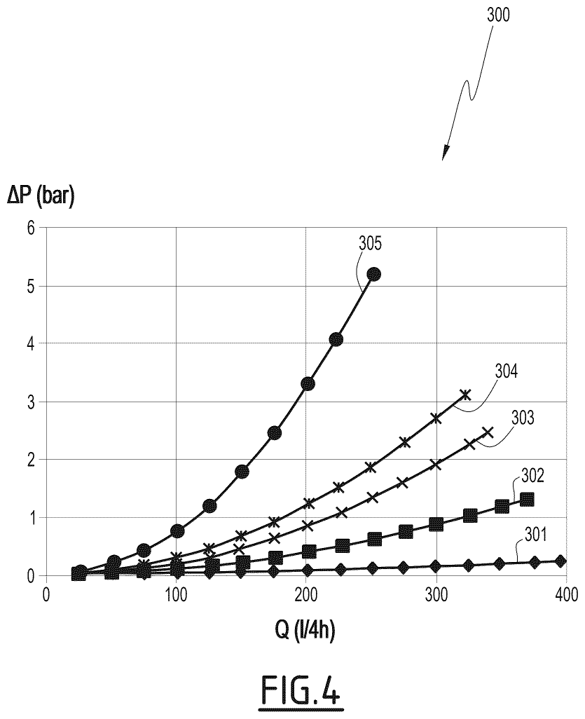

FIG. 4 is a graph 300 illustrating some of the advantages of the method according to the invention. The graph 300 shows a set of curves showing each differential pressure ΔP in bar as a function of fuel flow, in liter per hour—l/h—, through a filter at different clogging states. For a given fuel flow, for example at 200 l/h, the graph 300 comprises a first curve 301, which is the closest to the X axis and which corresponds to a new filter 50, with no clogging. The graph 300 presents a second curve 302, which is immediately above the first curve 301 and which corresponds to a filter with light clogging condition. The graph 300 presents a third curve 303, which is immediately above the second curve 302 and which corresponds to a filter with mild clogging condition. The graph 300 presents a fourth curve 304, which is immediately above the third curve 304 and which corresponds to a filter with heavy clogging condition. The graph 300 presents a fifth curve 305, which is the farthest from the X and which corresponds to a filter with severe clogging, requiring immediate replacement.

As mentioned before, for a given clogging state, the pressure differential ΔP is, roughly, proportional to the square of the fuel flow. However, for a truck operating in normal conditions, fuel consumption by the engine might not be enough to clearly discriminate between the various clogging states. For example, for an typical truck, with a “small” eight-liter displacement engine, average fuel consumption is around 10 l/hour, with peaks around 20 l/hour. Moreover, recent trends to equip trucks with automatic gearbox or to drive according to eco-driving principles tend to smoothen further the fuel consumption peaks. Although a truck engine might be designed to consume more fuel under certain specific conditions, it is not possible to foresee when these conditions will be met. Furthermore there conditions are most of the time transient. Accordingly, with prior art vehicles it is not possible to reliably measure pressure differential ΔP when consumption is high.

As shown on FIG. 4, for such a small fuel flow around 20 l/h, the curves 201 to 205 are overlapping, in other words it is difficult to analyze properly clogging state of the filter. Thanks to the invention, it is possible to increase fuel flow through the filter 50 several times more than the average fuel consumption of the engine 12. Preferably, when the pressure differential ΔP is measured, fuel flow through the filter 50 is at least four time higher than an average consumption of the engine 12, preferably five times higher, preferably eight times higher, preferably ten times higher, preferably twenty times higher.

The method of the invention is advantageously performed when the engine 12 does not consume any fuel. In other words, 100% of the fuel pumped by the pumping device 32 flows back to the tank 22, the eventual fuel leaks being neglected. While measuring differential pressure ΔP of the filter 50, at least 80% of the fuel pumped in the high-pressure circuit flows through the relief valve 40. For example, this situation may occur just after the engine 12 is turned off, as the engine 12 does not consume any fuel. Alternatively, when the apparatus is a vehicle, this situation may also occur when the vehicle is running downhill while using engine brake and/or electromagnetic brake. This situation is particularly adapted when the pumping device 32 is mechanically driven by the engine 12. Therefore, when the apparatus 10 is a vehicle, it is advantageous to measure differential pressure ΔP when the engine brake and/or electromagnetic brake—if relevant—are in use. Advantageously, navigation data are also taken into account, for example to detect that the vehicle is running on a long downhill slope ant that stable operating conditions may be expected for at least a few seconds before implementing the method of the invention.

Alternatively, the method of the invention is performed when the engine 12 consumes a minimal amount of fuel. For example, when the truck is idling, the engine running at minimal speed. In this situation, actual fuel consumption is minimal. Thanks to the invention, fuel flow through the filter 50 is several times higher than actual consumption, allowing for precise clogging evaluation despite minimal fuel consumption. Preferably, when the pressure differential ΔP is measured, fuel flow through the filter 50 is at least ten times higher than a minimal consumption of the engine 12, preferably twenty times higher, preferably thirty times higher, preferably four times higher.

Under these conditions, fuel flow through the filter 50 is not disturbed by fuel consumption and is very stable, allowing for a precise pressure differential ΔP measurement and precise clogging evaluation.

Alternatively, while measuring differential pressure of the filter 50, at least 50% of the fuel pumped in the high-pressure circuit flows through the pressure relief valve 40. Preferably, this situation occurs as the engine 10 runs at a stable regime, consuming fuel, for example just after the engine is turned on and runs at low speed, or when the engine runs at high speed. For example, when the apparatus 10 is a vehicle, when the vehicle runs on a highway.

In the illustrated example, the first pressure sensor P1 is arranged on the low-pressure circuit 36L between the first outlet 352 of and the filter 50. In a not-shown alternative, an additional third pressure sensor is arranged upstream from the primary filter 60, that is to say between the tank 20 and the first intake 351, in order to also measure a differential pressure associated to the primary filter 60 during the third step 103.

According to another not shown alternative, the first pressure P1 is arranged upstream from the primary filter 60. For example, the first pressure sensor P1 is part of a regeneration system, which is configured to inject fuel in a particle filter of the vehicle, so as to regenerate the particle filter. As a result, the method according to the invention allow measuring the pressure differential for both the main filter 50 and the primary filter 60, so as to evaluate overall clogging of the two filters. During normal maintenance of the apparatus 10, both filters 50/60 are changed simultaneously when clogging is detected.

Example 1: A fuel circuit 30, comprising:
a pumping device 32 comprising a low-pressure stage 34L and a high-pressure stage 34H, the fuel circuit 30 being configured to supply, at high-pressure, fuel 22 collected from a fuel tank 20 to injectors 16 of an engine 12,
   a low-pressure circuit 36L and a high-pressure circuit 36H,
   a fuel filter 50, which is arranged between an outlet 352 of the low-pressure stage 34L and an intake 353 of the high-pressure stage 34H,
   a fist pressure sensor P1 arranged upstream from the fuel filter 50, and
   a second pressure sensor P2 arranged between the fuel filter 50 and the intake 353 of the high-pressure stage 34H.

Example 2: The fuel circuit 30 according to example 1, wherein the fuel circuit further comprises:
a pressure relief valve 40, which is arranged on the high-pressure circuit 36H, and
a control unit 42, which is configured to control the pumping device 32 and the pressure relief valve 40, and to evaluate a differential pressure ?P of the filter 50 when fuel flows through the filter 50.

Example 3: An apparatus 10, comprising:
an engine 12 with injectors 16, which are configured to inject fuel at high-pressure into cylinders 14 of the engine 12,
the fuel tank 20, and
the fuel circuit according to any one of examples 1 or 2.

Example 4: The apparatus 10 according to example 3, wherein:
the apparatus 10 is a vehicle or a power generator.

Example 5: A method to evaluate clogging of a fuel filter 50 of a fuel circuit 30 for an apparatus 10, the method comprising:
pumping fuel 101, with a pumping device 32 of the fuel circuit, the pumping device 32 comprising a low-pressure stage 34L and a high-pressure stage 34H, the fuel circuit 30 comprising a low-pressure circuit 36L with the fuel filter 50 and a high-pressure circuit 36H, the fuel filter 50 being arranged between an outlet 352 of the low-pressure stage 34L and an intake 353 of the high-pressure stage 34H,
while pumping fuel, measuring 103 a fuel pressure downstream of the fuel filter 50, with a pressure sensor P2 arranged between the fuel filter 50 and the intake 353 of the high-pressure stage 34H,
with a control unit 42, comparing 104 the measured fuel pressure with expected values of the fuel pressure, the expected values being preferably stored in a memory of the control unit.

Example 6: The method according to example 5, wherein:
measuring 103 fuel pressure downstream of the fuel filter 50 occurs during a startup period of the apparatus 10, the measured fuel pressure being initially zero,
when comparing 104 the measured fuel pressure with expected values of the fuel pressure, the control unit 42 is configured to report a fault if the measured fuel pressure does not reach a predetermined threshold TH1 before a predetermined time T3, the predetermined threshold and the predetermined time being preferably stored in a memory of the control unit 42.

Example 7: The method according to example 5, wherein:
measuring 103 fuel pressure downstream of the fuel filter 50 occurs after a startup period of the apparatus 10, the fuel pressure varying according to operating conditions of the apparatus 10,
when comparing 104 the measured fuel pressure with expected values of the fuel pressure, for any possible operating condition of the apparatus 10, a fault is reported if the measured fuel pressure does not stay within a range of expected values, the range of expected value being delimited, between a minimal value 202 and a maximal value 203, the minimal value and the maximal value being each function of the operating conditions.

Example 8: The method according to example 5, wherein:
while pumping fuel 101, opening 102 a pressure relief valve 40 of the high-pressure circuit 36H, in order to increase fuel flow through the fuel filter 50 above a pre-determined threshold,
while pumping fuel and while the pressure relief valve 50 is open, measuring 103 a differential pressure ΔP of the fuel filter 50, with the first pressure sensor P2 and the second pressure sensor P2.

Example 9: The method according to example 8, wherein:
while measuring 103 differential pressure ΔP of the filter 50, at least 50% of the fuel pumped in the high-pressure circuit 36H flows through the pressure relief valve 40.

Example 10: The method according to any one of examples 8 or 9, wherein:
while measuring 103 differential pressure ΔP of the filter 50, 100% of the fuel pumped by the pumping device 32 flows back to the fuel tank 20.

Example 11: The method according to any one of examples 8 to 10, wherein:
while measuring 103 differential pressure ΔP of the filter 50, the engine 12 runs at a constant speed.

Example 12: The method according to example 11, wherein:
the apparatus 10 being a vehicle, while measuring 103 differential pressure ΔP of the filter 50, the vehicle is using engine brake and/or electromagnetic brake.

Example 13: The method according to any one of examples 8 to 12, wherein:
while measuring 103 differential pressure ΔP of the filter 50, the fuel flow through the filter 50 is higher than ten times a fuel consumption of the engine 12 when the engine is idling, preferably higher than twenty times, preferably higher than thirty times, preferably higher than forty times.

Example 14: The method according to any one of examples 8 to 13, wherein:
while measuring 103 differential pressure ΔP of the filter 50, the fuel flow through the filter 50 is at least four time higher than an average consumption of the engine 12, preferably five times higher, preferably eight times higher, preferably ten times higher, preferably twenty times higher.

Example 15: The method according to any one of examples 8 to 13, wherein:
differential pressure ΔP of the filter 50 is measured several times during an operating cycle of the apparatus 10,
each measured value is divided by an end of life value of the differential pressure, then averaged, in order to calculate a ratio representative of remaining lifetime of the filter.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A fuel circuit, comprising:
a pumping device comprising a low-pressure stage and a high-pressure stage, the fuel circuit being configured to supply, at high-pressure, fuel collected from a fuel tank to injectors of an engine,
a low-pressure circuit and a high-pressure circuit,
a fuel filter, which is arranged between an outlet of the low-pressure stage and an intake of the high-pressure stage,
a fist pressure sensor arranged upstream from the fuel filter, and
a second pressure sensor arranged between the fuel filter and the intake of the high-pressure stage.

2. The fuel circuit according to claim 1, wherein the fuel circuit further comprises:
a pressure relief valve, which is arranged on the high-pressure circuit, and
a control unit, which is configured to control the pumping device and the pressure relief valve, and to evaluate a differential pressure of the filter when fuel flows through the filter.

3. An apparatus, comprising:
an engine with injectors, which are configured to inject fuel at high-pressure into cylinders of the engine,
the fuel tank, and
the fuel circuit according to claim 1.

4. The apparatus according to claim 3, wherein:
the apparatus is a vehicle or a power generator.

5. A method to evaluate clogging of a fuel filter of a fuel circuit for an apparatus, the method comprising:
pumping fuel, with a pumping device of the fuel circuit, the pumping device comprising a low-pressure stage and a high-pressure stage, the fuel circuit comprising a low-pressure circuit with the fuel filter and a high-pressure circuit, the fuel filter being arranged between an outlet of the low-pressure stage and an intake of the high-pressure stage,
while pumping fuel, measuring a fuel pressure downstream of the fuel filter, with a pressure sensor arranged between the fuel filter and the intake of the high-pressure stage, with a control unit, comparing the measured fuel pressure with expected values of the fuel pressure, the expected values being preferably stored in a memory of the control unit.

6. The method according to claim 5, wherein:
measuring fuel pressure downstream of the fuel filter occurs during a startup period of the apparatus, the measured fuel pressure being initially zero,
when comparing the measured fuel pressure with expected values of the fuel pressure, the control unit is configured to report a fault if the measured fuel pressure does not reach a predetermined threshold before a predetermined time, the predetermined threshold and the predetermined time being preferably stored in a memory of the control unit.

7. The method according to claim 5, wherein:
measuring fuel pressure downstream of the fuel filter occurs after a startup period of the apparatus, the fuel pressure varying according to operating conditions of the apparatus,
when comparing the measured fuel pressure with expected values of the fuel pressure, for any possible operating condition of the apparatus, a fault is reported if the measured fuel pressure does not stay within a range of expected values, the range of expected value being delimited, between a minimal value and a maximal value, the minimal value and the maximal value being each function of the operating conditions.

8. The method according to claim 5, wherein:
while pumping fuel, opening a pressure relief valve of the high-pressure circuit, in order to increase fuel flow through the fuel filter above a pre-determined threshold,
while pumping fuel and while the pressure relief valve is open, measuring a differential pressure of the fuel filter, with the first pressure sensor and the second pressure sensor.

9. The method according to claim 8, wherein:
while measuring differential pressure of the filter, at least 50% of the fuel pumped in the high-pressure circuit flows through the pressure relief valve.

10. The method according to claim 8, wherein:
while measuring differential pressure of the filter, 100% of the fuel pumped by the pumping device flows back to the fuel tank.

11. The method according to claim 8, wherein:
while measuring differential pressure of the filter, the engine runs at a constant speed.

12. The method according to claim 11, wherein:
the apparatus being a vehicle, while measuring differential pressure of the filter, the vehicle is using engine brake and/or electromagnetic brake.

13. The method according to claim 8, wherein:
while measuring differential pressure of the filter, the fuel flow through the filter is higher than ten times a fuel consumption of the engine when the engine is idling, preferably higher than twenty times, preferably higher than thirty times, preferably higher than forty times.

14. The method according to claim 8, wherein:
while measuring differential pressure of the filter, the fuel flow through the filter is at least four time higher than an average consumption of the engine, preferably five times higher, preferably eight times higher, preferably ten times higher, preferably twenty times higher.

15. The method according to claim 8, wherein:
differential pressure of the filter is measured several times during an operating cycle of the apparatus,
each measured value is divided by an end of life value of the differential pressure, then averaged, in order to calculate a ratio representative of remaining lifetime of the filter.
